(19) United States
(12) Patent Application Publication
(10) Pub. No.: US 2009/0074387 A1
(43) Pub. Date: Mar. 19, 2009

(54) INFORMATION PLAYBACK SYSTEM, DATA GENERATION APPARATUS AND DATA PLAYBACK APPARATUS

(76) Inventor: Masaharu Adachi, Osaka (JP)

Correspondence Address: DICKSTEIN SHAPIRO LLP, 1825 EYE STREET NW, Washington, DC, 20006-5403, US

(21) Appl. No.: 12/211,693

(22) Filed: Sep. 16, 2008

(30) Foreign Application Priority Data
Sep. 18, 2007 (JP) 2007-241591

(51) Int. Cl. H04N 7/26

(52) U.S. Cl. 386/124

(57) ABSTRACT

An information playback system includes a first and second information processor. The first information processor generates digital data based on image or sound and includes an encoder to encode the image or audio signal to digital data, a storage to store the digital data in a storage, a first hardware interface to connect the first information processor to a second information processor, and a storage-class software interface to permit the second information processor to access the storage without using image-class software interface. The second information processor playbacks the digital data and includes a second hardware interface to connect the second information processor to the first information processor, a software interface to mount the storage to a file system, and a playback device to playback the digital data.

### CROSS-REFERENCE TO RELATED APPLICATIONS

This patent specification is based on and claims priority from Japanese Patent Application No. 2007-241591, filed on Sep. 18, 2007 in the Japan Patent Office, the entire contents of which are hereby incorporated by reference herein.

### BACKGROUND

1. Field of the Invention

The present invention relates to an information playback system, a data generation apparatus and a data playback apparatus, and more specifically, to an information playback system, a data generation apparatus and a data playback apparatus achieving easy handling of an imaging device.

2. Description of the Related Art

Recently, a variety of different types of peripheral devices which can connect to a computer have been developed. For such peripheral devices, it is important to achieve an easy connection to the computer. Accordingly, many connection methods have been proposed. One example of such connection methods is a classification scheme in which the peripheral devices are classified into device classes. For example, if an imaging device such as a CCD (Charge-Coupled Device) camera or a TV-tuner is the peripheral device to be connected to the computer, an image-class device-driver is known as a minimum required device class for connecting such an imaging device to the computer.

FIG. 1 is a schematic diagram illustrating a known computer system in which imaging devices are connected to a computer. In FIG. 1, the imaging device 200 includes a camera and a microphone. The camera takes an image, and the microphone collects a sound. The image and the sound are digitized by a video-and-audio encoder, and are transmitted by an image-class interface to the computer through a peripheral interface using a predetermined transmission method. The peripheral interface is a physical layer. When the computer is defined as “main” and the imaging device 200 is defined as “sub”, the computer is a host computer in this computer system. The computer receives digital data through the peripheral interface using an image-class device-driver, and uses the digital data with application software.

As for a connection between the imaging device 200 and the computer, various technologies have been proposed.

In a known image outputting system in which an imaging device is used as a stand-alone device, image and sound files are stored in a storage device. Then, the imaging device sends a command to the computer when the imaging device is connected to the computer. However, this image outputting system just stores the digital data in the storage device. A moving image can not be transmitted to the computer in real time because the imaging device is a stand-alone device and the storage device can not be a substitute for an interface of the imaging device.

In another known computer system, an image-class device-driver and a storage-class device-driver are provided at a computer side to transfer a moving image, a sound, and a still image. The moving image is handled by the image-class device-driver, and the still image is handled by the storage-class device-driver. However, it is not possible to connect the imaging devices using the storage-class device-driver.

As previously described with reference to FIG. 1, when the application software uses the image and sound data of the imaging device 200, it is necessary to have a dedicated service for the imaging device 200 in the image-class device-driver. However, the image-class device-driver may not include all of the services for the imaging device 200. Accordingly, the image-class device-driver needs to prepare a required function for each peripheral device.

Similarly, it is necessary that the image-class device-driver have a specific service function so that the imaging device 200 operates a specific function, for example, changing a channel of a TV tuner. Generally, image and sound data can not be played back automatically when the imaging device 200 is connected to the system and is recognized. Accordingly, it is necessary to load and run dedicated software in advance so as to detect and identify the imaging device 200. Further, image and sound data are always written in the storage device and are overwritten repeatedly in the same area of the storage device, resulting in overload to the storage device.

### SUMMARY

This patent specification describes a novel information playback system that includes a first and second information processor. The first information processor generates digital data based on image or sound and includes an encoder to encode the image or audio signal as digital data, a storage to store the digital data, a first hardware interface to connect the first information processor to the second information processor, and a storage-class software interface to permit the second information processor to access the storage without using image-class software interface. The second information processor plays back the digital data and includes a second hardware interface to connect the second information processor to the first information processor, a first software interface to mount the storage to a file system, and a playback device to play back the digital data.

This patent specification further describes a novel data generation apparatus to generate digital data from image or sound. The data generation apparatus includes an encoder to encode image or sound as digital data, a storage to store the digital data, a hardware interface to connect an information processor, and a storage-class software interface to permit the information processor to access the storage without using an image-class software interface.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a known computer system;

FIG. 2 is a schematic diagram illustrating a configuration of a computer system according to a first example embodiment;

FIG. 3 is an example block diagram of the computer system of FIG. 2;

FIG. 4 is an example sequence of playing back a video-and-audio (A/V) file transferred from the imaging device by the computer;

FIG. 5 is a schematic diagram illustrating a computer system according to a first modification of the first example embodiment;

FIG. 6 is a schematic diagram illustrating a computer system according to a second modification of the first example embodiment;

FIG. 7 is a schematic diagram illustrating a computer system according to a third modification of the first example embodiment;

FIG. 8 is a schematic diagram illustrating a computer system according to a fourth example embodiment;

FIG. 9 is a schematic diagram illustrating an imaging device according to a fifth example embodiment;

FIG. 10 is a schematic diagram illustrating an imaging device according to a sixth example embodiment;

FIG. 11 is a schematic diagram illustrating an imaging device according to a seventh example embodiment;

FIG. 12 is a schematic diagram illustrating an example of an operation menu of the imaging device;

FIG. 13 is a schematic diagram illustrating a configuration of a disk according to a ninth example embodiment; and

FIGS. 14A, 14B, 15A and 15B are schematic diagrams each of which illustrates a configuration of another disk according to a tenth example embodiment.

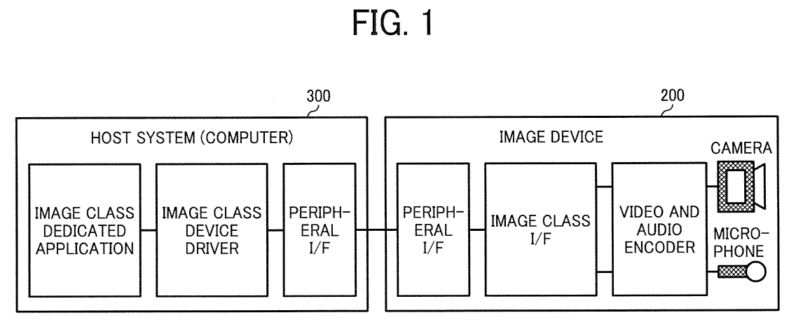

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

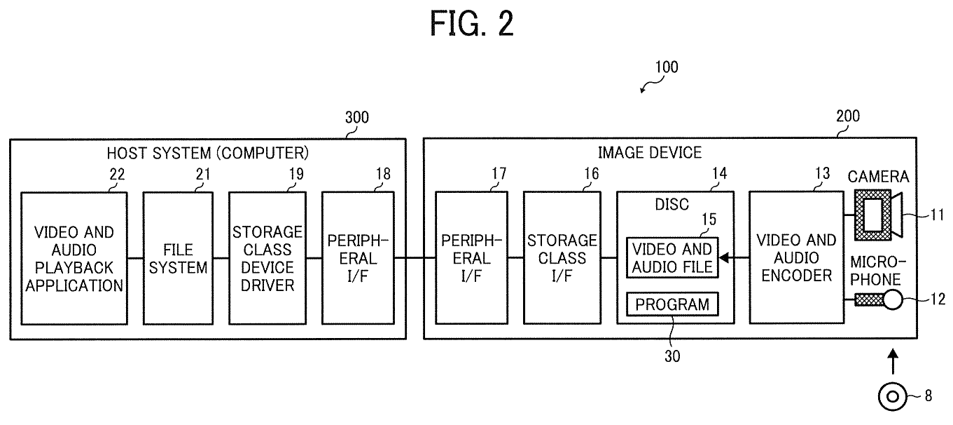

Referring now to the drawings, wherein like reference numerals designate identical or corresponding parts throughout the several views thereof, and in the first instance to FIG. 2, a computer system according to exemplary embodiments of the present invention is described.

### First Example Embodiment

FIG. 2 is a schematic diagram illustrating a configuration of a computer system 100 according to a first example embodiment. The computer system 100 includes an imaging device 200 and a computer 300. In the computer system 100 according to the first example embodiment, the imaging device 200 is handled as a storage device so that an image-class device-driver is not required for each peripheral apparatus. Further, it becomes possible to play back image and sound data automatically when the imaging device 200 is connected to the computer system 100 and is recognized by the computer 300. Thus, in this computer system 100 according to the first example embodiment, it is possible to make the imaging device 200 operate using a storage-class device-driver supported by the OS (Operating System).

The storage-class device-driver in the computer 300 is connected to a storage-class interface (I/F) in the imaging device 200 that is a pair with the storage-class device-driver. As a result, the imaging device 200 is handled by the storage-class I/F, making the following possible:

the imaging device 200 is recognized as a drive

a drive character is assigned

of file systems (mounted)

By contrast, an image-class device-driver is connected to an image-class interface (I/F) as a pair. As a result, the imaging device 200 is handled by the image-class I/F, making it possible to use API (Application Interface) such as video (encoder and decoder), audio (speaker and microphone) and so on.

Therefore, the storage-class I/F handles the imaging device 200 like a drive such a hard disk, and the image-class I/F handles the imaging device 200 like a video-and-audio device such as a camera.

In FIG. 2, the imaging device 200 is connected to the computer 300 (host computer) through a high speed serial interface such as USB (Universal Serial Bus) and IEEE (Institute of Electrical and Electronics Engineers) 1395 by wired connection or wireless connection in the computer system 100. For example, the computer 300 may be a personal computer, a mobile phone, PDA (Personal Digital Assistant), and so on. The imaging device 200 is detachably connected to the computer 300. The computer 300 can play back video data taken by a camera 11 included in the imaging device 200 and sound data captured by a microphone 12. (Hereinafter, the video data and the sound data are expressed as video-and-audio generated by the imaging device 200.) Further, as for a data transfer protocol for the USB, one transfer protocol is selected to apply among a plurality of transfer protocols such as control transfer, bulk transfer, interrupt transfer, isochronous transfer, and so on.

Both the imaging device 200 and the computer 300 include an image processing unit. A CPU (Central Processing Unit), ROM (Read Only Memory), RAM (Random Access Memory), and input/output unit and so on are connected to the image processing unit through a bus line. The CPU achieves a desired capability, described later, by implementing a variety of programs 30.

The computer 300 includes a peripheral I/F 18, a storage-class device-driver 19, file system 21 and video-and-audio playback application 22. The peripheral I/F 18 provides a USB interface, and the storage-class device-driver 19 transmits and receives data by controlling the peripheral I/F 18. The file system 21 controls storage positions for a video-and-audio (A/V) file 15, and the video-and-audio playback application 22 plays back the video and audio.

The peripheral I/F 18 is a physical layer and also a data link layer. Accordingly, the peripheral I/F 18 makes cable connections physically. Further, the computer 300 performs transmission control of the video-and-audio data transmitted between the storage-class device-driver 19 and the computer 300 that is the host computer. The storage-class device-driver 19 is driver software to control the imaging device 200 through the peripheral I/F 18 and runs on an OS, for example, Linux (registered trademark), Windows OS (registered trademark), or Mac OS (registered trademark). The imaging device 200 may not be supported by Linux (registered trademark) and MacOS (registered trademark) because the market shares of both Linux and MacOS are small. In this example embodiment, however, since the imaging device 200 can be handled as a storage device, the computer 300 which runs on Linux or MacOS can use a standard storage-class device-driver 19 to connect the imaging device 200. Accordingly, it is not necessary to develop an image-class device-driver dedicated to the imaging device 200. The standard storage-class device-driver is, for example, a USB mass storage-class device-driver.

The storage-class device-driver 19 according to the first example embodiment provides a driver function in storage-class as the name suggests. When a USB connection is employed, the storage-class device-driver 19 corresponds to a USB mass storage-class device-driver, so that a peripheral device such as the imaging device 200 is recognized as a drive unit similarly to the storage device such as HDD (hard disk drive), etc. Since the storage-class device-driver 19 is included in the OS, the computer 300 recognizes a disk 14 and a A/V file 15 without installing additional dedicated software to the computer 300. When the video-and-audio playback application 22 plays back the A/V file 15, the storage-class device-driver 19 transmits a read command to access the disk 14. A bulk transfer or an isochronous transfer may be employed to transmit the A/V file 15 from the imaging device 200 to the computer 300. In the isochronous transfer, a predetermined amount of video-and-audio data is transferred at each flame.

The imaging device 200 includes, for example, a peripheral I/F 17, a storage-class I/F 16, a disk 14 that is a storage and a video-and-audio encoder 13. The peripheral I/F 17 provides a USB hardware interface similar to the peripheral I/F 18 in the computer 300. The storage-class IF 16 corresponds to the storage-class device-driver 19, and is an interface to control detection of commands included in interrupt transfer data and control transfer data sent from the computer 300 and to control data conversion in accordance with the bulk transfer or an isochronous transfer. The imaging device 200 may be a USB One-Seg-Tuner, a USB camera, or any unit that converts image information such as video and audio to digital data. The detected command is provided to a variety of units, and will be described later.

When the imaging device 200 is connected to the computer 300 and the A/V file 15 is requested through the video-and-audio playback application 22 by a user, the storage-class IF 16 transmits the A/V file 15 to the computer 300, for example, by an isochronous transfer. The disk 14 may be a nonvolatile memory such as a flash memory and a hard disk drive, a RAM such as a DRAM (dynamic random access memory), and a rewritable light disk such as DVD-RAM. Further, the disk 14 may be removable or fixed to the imaging device 200.

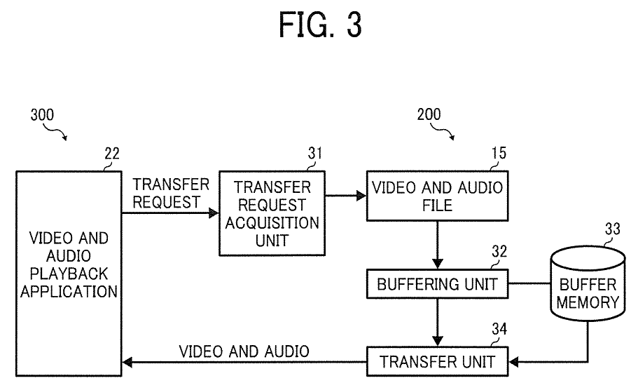

The disk 14 stores a program 30. A block diagram of the program 30 is shown in FIG. 3. The program 30 may be obtained by a storage medium such as memory card, and transmitted from the computer 300 to install on the disk 14. The video-and-audio encoder 13 encodes video data and audio data, and generates the A/V file 15 in a form of a file format such as MPEG-4 (Moving Expert Group phase 4) file and ASF (Advanced Systems Format) file, each of which is an appropriate format for streaming.

FIG. 3 is an example block diagram of the computer system 100. The imaging device 200 includes a transfer-request-acquisition unit 31, a buffering unit 32 and a transfer unit 34, each of which is realized by implementing the program 30 by the computer 300.

The transfer-request-acquisition unit 31 receives a transfer request of the A/V file 15 requested by the video-and-audio playback application 22 of the computer 300. In this example embodiment, the A/V file 15 is handled as a storage device, so that the computer 300 includes the storage-class device-driver 19 and the imaging device 200 includes the storage-class IF 16. Accordingly, a delivery request is completed if the file system 21 designates a file name. If the A/V file 15 is defined to be a predetermined file name, designation of the file name constitutes a transfer request of the A/V file 15.

The buffering unit 32 buffers the A/V file 15 to a buffer memory 33. The video-and-audio encoder 13 generates A/V files 15 sequentially, subject to processing capability and bit rate. The A/V file 15 is written from a first part of the A/V file 15 transferred to the computer 300. If an amount of the A/V file 15 transferred to the computer 300 exceeds a predetermined amount, an exceeding A/V file 15 is overwritten onto the first part of the A/V files 15 written previously. These writing processes are repeated.

The buffering unit 32 repeats buffering of the A/V file 15 as much as possible to accomplish real-time processing. If a buffering speed depends on a transfer speed at the isochronous transfer performed by the transfer unit 34, the transfer speed with which the transfer unit 34 transfers the A/V file 15 synchronizes the buffering speed. Accordingly, it is possible to transfer the A/V file 15 with a minimum of dropped frames.

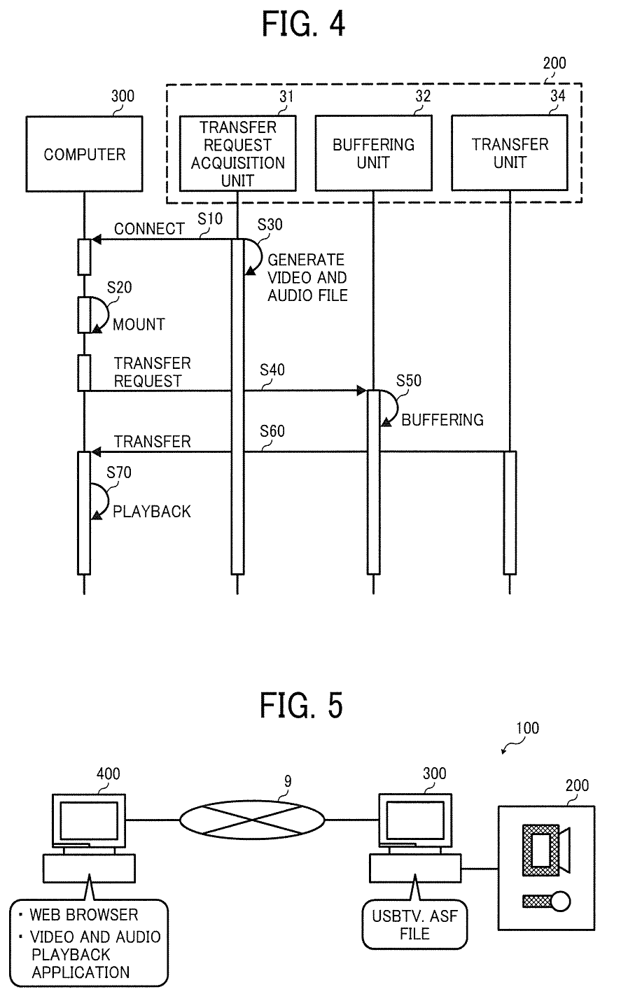

FIG. 4 is an example sequence for playing back the A/V file 15 transferred from the imaging device 200 by the computer 300.

When the imaging device 200 is connected to the computer 300 that runs on Linux (registered trademark), the computer 300 recognizes the imaging device 200 as a USB mass storage device. (S10) Since the imaging device 200 is recognized as a storage device, a drive character is assigned to the imaging device 200 to operate like a drive when the computer 300 mounts the imaging device 200. (S20) The video-and-audio encoder 13 encodes video and audio input through the camera 11 and the microphone 12, for example, in MPEG-4 format, and generates an A/V file 15 on the disk 14. (S30) If the A/V file 15 is named, for example, as USBTV and ASF, a USBTV or an ASF file is recognized as present on the mounted drive.

When a user browses the USBTV or the ASF on the mounted drive using the video-and-audio playback application 22 (media playback application) that is general purpose software, the A/V file 15 is transferred from the imaging device 200. (S60) The video-and-audio playback application 22 plays back and displays the A/V file 15. (S70) Thus, it is possible to view the video taken by the camera 11 without installing a dedicated device driver for the (USB) camera 11 and a dedicated video-image-browse-application.

### First Modification of the First Example Embodiment

In the first example embodiment, the A/V file 15 is played back by the computer 300. However, the A/V file 15 may be played back by a computer 400 that is connected through a network 9. The video data taken by the camera 11 and the sound data captured by the microphone 12 are transmitted to the computer 400 that is connected to the network 9. The computer 400 may be used in a meeting held at a remote video conference room.

FIG. 5 is a schematic diagram illustrating a computer system 100 according to a first modification of the first example embodiment. Each configuration of an imaging device 200 and a computer 300 in FIG. 5 is similar to the corresponding configuration thereof in FIG. 2, although the computer 300 of FIG. 5 releases the USBTV and the ASF files to the network 9. Accordingly, the computer system 300 operates as a server, stores HTML files embedding the USBTV and the ASF files, and sends the USBTV and the ASF files in response to a request from a client computer.

In FIG. 5, the computer 400 is a client computer. The computer 400 implements client software, such as a WEB browser, and sends a transmission request for USBTV and ASF files to the computer 300. The computer system 100 may be a file-sharing-type system, in which it is possible to use the USBTV and ASF files shared by both computers 300 and 400.

The computer 400 includes a video-and-audio playback application 22 that supports MPEG-4 in addition to the WEB browser. If the USBTV and ASF files are released to the network or shared by the computers 300 and 400, the computer 400 can access the USBTV and ASF files to browse.

As a result, it is possible to have a remote video conference by the computer 400 through the network 9 without installation of a dedicated device driver and a video-image-browse-application.

### Second Modification of the First Example Embodiment

In the embodiments described previously, the A/V files 15 generated by the camera 11 and the microphone 12 are handled as an imaging device 200. If a TV-tuner that receives an image and a sound is handled as an imaging device 200, similar problems will occur. More specifically, when the TV-tuner that includes an interface such as a USB is connected to a computer 300 that runs on Windows OS (registered trademark), it is not possible to view a TV-image. To view the TV-image, it is necessary to install an image-class device-driver and a dedicated TV-browsing application.

Similar to the first example embodiment, if the A/V files 15 is generated from the image and the sound received by the TV-tuner, it becomes possible to play back the image and the sound without an image-class device-driver and a video-image-browse-application.

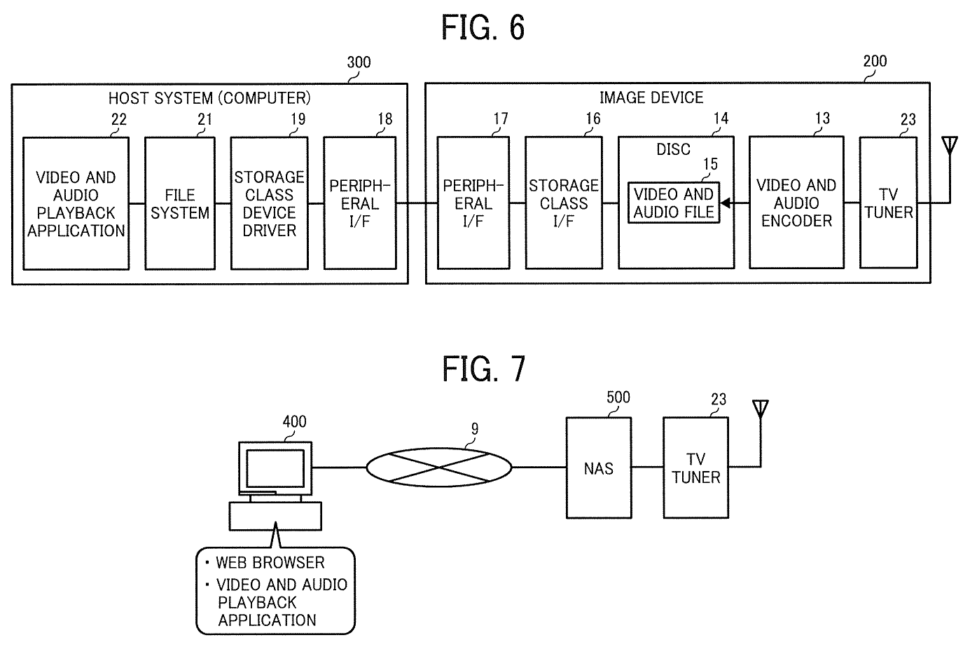

FIG. 6 is a schematic diagram illustrating a computer system 100 according to a second modification of the first example embodiment. In FIG. 6, identical reference characters are assigned to identical or similar configuration members shown in FIG. 3 and descriptions thereof are omitted.

In FIG. 6, the computer system 100 includes a TV-tuner 23 instead of the camera 11 and the microphone 12. When the imaging device 200 is connected to the computer 300 that runs on Windows OS (registered trademark), the computer 300 recognizes the imaging device 200 as a USB mass storage device. The computer 300 assigns a drive character to cause the imaging device 200 to function as a drive. At the same time, the storage-class device-driver 19 is installed automatically so that it is not necessary for a user to install the storage-class device-driver 19. The imaging device 200 encodes the image and the sound input through the TV-tuner 23, for example, using MPEG-4 to store encoded data as USBTV and ASF files on the disk 14. The user can then view the image and the sound with the video-and-audio playback application 22 such as Windows Media player (registered trademark) simply by selecting the USBTV and ASF files on the drive by the file system 21. Thus, it becomes possible to view the image and the sound generated by the TV-tuner of the imaging device 200 without installation of a dedicated TV-image-browse application for TV-tuner 23.

### Third Modification of the First Example Embodiment

A computer system 100 using a network 9 will be described. The image and the sound received by a TV-tuner can be viewed remotely through the network 9 in the computer system 100.

When the TV-tuner 23 is connected to the computer 300 that runs on Windows OS (registered trademark) or to a router having a network-attached-storage (hereinafter NAS) function, it is not possible to view a TV-image.

To view the TV-image, it is necessary to install an image-class device-driver, and a dedicated TV-browsing application. Further, it is necessary to install an OS for router, an image-class device-driver, and a dedicated TV-browsing application to view the TV-image through the NAS.

By contrast, when the imaging device 200 according to the third modification of the first example embodiment is connected to a router 500 having the NAS function, the computer 300 recognizes the imaging device 200 as a USB mass storage device. Further, the OS for router recognizes the imaging device 200 as a folder.

FIG. 7 is a schematic diagram illustrating a computer system 100 according to a third modification of the first example embodiment. Each configuration of an imaging device 200 and the NAS 500 in FIG. 7 is similar to the corresponding configuration thereof in FIGS. 2 and 6. However, FIG. 7 is different from the computer system 100 in FIGS. 2 and 6 in that the NAS 500 is connected to the network 9. In this computer system, file sharing is established either automatically or manually by a user on the network 9, so that it is not necessary for the user to install the storage-class device-driver 19 to the router.

The imaging device 200 encodes the image and the sound input through the TV-tuner 23, for example, using MPEG-4 to store encoded data as USBTV and ASF files in the folder. The user can view the USBTV and ASF files shared on the network 9 by the router by the video-and-audio playback application 22 such as Windows Media player (registered trademark) from the computer 400. Thus, it becomes possible to view the TV-image through the network without installation of a dedicated TV browse application for TV-tuner 23.

### Second Example Embodiment

As for recording of an image and a sound by a TV-tuner 23, it is not possible to record a TV-image just by hooking up a TV-tuner 23 to a computer 300 that runs on Windows OS (registered trademark). To record the TV-image, it is necessary to install an image-class device-driver, and a dedicated TV-recording application.

However, if the imaging device 200 is handled as a storage device with an identical or a similar configuration to the first example embodiment, the image and the sound received by the TV-tuner can be recorded. A schematic of the configuration is same as FIG. 6. The A/V file 15 encoded by the video-and-audio encoder 13 is stored in a disk 14.

In the first example embodiment, if a file size exceeds a predetermined size, the excess portion of the file is overwritten. In the second example embodiment, however, the disk 14 has sufficient capacity to store the entire A/V file 15 to be recorded for a predetermined recording time.

When the imaging device 200 is connected to the computer 300 that runs on Windows OS (registered trademark), the imaging device 200 is recognized as a USB mass storage device by the computer 300 and a drive character is assigned to the imaging device 200 by the Windows OS (registered trademark). At the same time, the storage-class device-driver 19 is installed automatically so that it is not necessary for a user to install the storage-class device-driver 19 separately.

The imaging device 200 encodes the image and the sound input through the TV-tuner 23, for example, using MPEG-4 and stores the encoded data as USBTV and ASF files on the disk 14. Thus, it becomes possible to record the TV-image without installation of a dedicated TV browse application for TV-tuner 23. Since the recorded A/V files 15 (USBTV and ASF files) is a single file that does not change contents, the recorded A/V files 15 can be played back by the video-and-audio playback application 22 on the computer 300. Further, the A/V files 15 may also be played back after the A/V files 15 is copied to the computer 300 or other drive. Thus, according to the second example embodiment, it becomes possible to record and view the image received by the TV-tuner 23 without installation of an image-class device-driver dedicated for TV-tuner and a TV-browse application.

### Third Example Embodiment

The disk 14 is mounted automatically when the imaging device 200 is handled as a storage device in the first and the second example embodiments. However, there is always a possibility that the A/V files 15 may be removed accidentally from the computer 300. Especially when the A/V files 15 is removed after a television program is recorded by the TV-tuner 23, the TV-image and the sound may be erased completely. If the A/V files 15 is removed, operation error may occur at a playback and saving operations of the A/V files 15. Accordingly, it is preferable to recognize the imaging device 200 as a read-only drive like a CD-ROM (Compact Disk-Read-Only Memory). With this configuration, it becomes possible to avoid accidental operations, for example, removing file, formatting a recorded file, and so on. In Windows OS (registered trademark), a file or a drive can be a read-only drive if a file property or a drive property is set to “read-only”. A user can view the TV-image because the A/V files 15 is readable even if a file or a drive is set to be a read-only drive.

### Fourth Example Embodiment

In a fourth example embodiment, a computer system 100, which plays back and displays the A/V files 15 automatically when the imaging device 200 is connected to the computer 300, will be described.

As described previously, it is not possible to play back a TV-image automatically even if a TV-tuner 23 is connected to a computer 300 in which the image-class device-driver and the TV-browse application have been installed. To view the TV-image automatically, the computer 300 needs to have resident software that detects connection of the TV-tuner 23. Further, when connection of the TV-tuner 23 is detected, the resident software starts the TV-browse application dedicated for the TV-tuner 23.

As described previously, When the imaging device 200 is connected to the computer 300 that runs on Windows OS (registered trademark), the imaging device 200 is recognized as a USB mass storage device by the computer 300. Then, a drive character is assigned by the Windows OS(registered trademark) so that the imaging device 200 can be handled as a drive. When the medium such as CD-ROM is set in a drive, the OS starts application software or another operation automatically in accordance with a setting of AUTORUN and INF29. Accordingly, automatic implementation of, for example, implementing the application software and opening the file, becomes possible if AUTORUN and INF29 are stored at a root directory of USB mass storage.

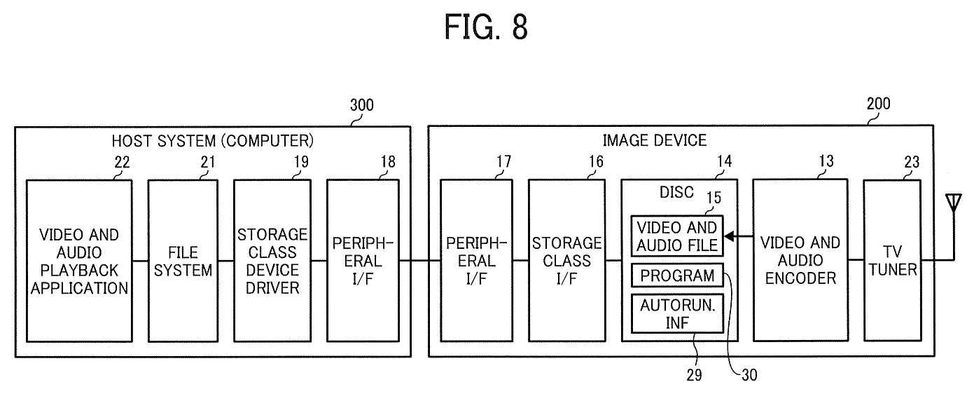

FIG. 8 is a schematic diagram illustrating a computer system 100 according to a fourth example embodiment. In FIG. 8, AUTORUN and INF29 are stored on the disk 14. If processing to open the USBTV and ASF files on the drive is described on the AUTORUN and INF29, the computer 300 displays the TV-image automatically when the TV-tuner 23 is connected. The following shows example descriptions on AUTORUN and INF29.

[Autorun]

open=wmplayer.exe usbtv.asf

Thus, in the computer system 100 according to the fourth example embodiment, it becomes possible to display and view the image automatically without using resident software that detects connection of the imaging device 200 when the imaging device 200 is connected to the computer 300.

### Fifth Example Embodiment

A fifth example embodiment describes changing a channel by controlling the imaging device 200, that is the TV-tuner 23 from the computer 300.

As described in the second modification of the first example embodiment, the USBTV and ASF files, which are stored from the TV-tuner 23 of the imaging device 200, are displayed on the drive recognized as a USB mass storage device by the computer 300 that runs on Windows OS (registered trademark). Then, it becomes possible to view the image and the sound with the computer 300 when the USBTV and ASF files are opened.

When the imaging device 200 is recognized as a USB mass storage device, it is possible to write to and read from the files stored therein, however, there is no way to change the channel. Accordingly, it is possible only to view an image and a sound at a fixed channel.

As the second example embodiment, when the TV-tuner 23 of the imaging device 200 records an image and a sound as USBTV and ASF files on a drive that is recognized as a USB mass storage device by the computer 300 that runs on Windows OS (registered trademark), possible operations are limited. For example, recording operation is possible but only for a fixed period from an insertion of the imaging device 200 because start and stop operations are not possible.

According to the fifth example embodiment, it is possible to change a channel by:

i) preparing an operation setting file 27 having name and instruction related to each operation at an operation setting of the imaging device 200 to read a file on a storage device,

ii) preparing an address comparison table 24 which describes operational instructions corresponding to a file allocation table (hereinafter “FAT”) of the operation setting file 27, and an address comparison table 24 which describes operational contents corresponding to physical address stored in the operation setting file 27,

iii) comparing the physical address and the contents of the address comparison table 24 by an address comparator when the operation setting file 27 is read, and

iv) performing operation and setting of the corresponding operational contents in the address comparison table 24 on the imaging device 200 by an imaging device-operation-setting device 26 when the physical address matches the contents of the address comparison table 24.

With this procedure, it becomes possible to change and set a channel of the TV-tuner 23, for example, to “2” by reading a corresponding part of the operation setting file 27 that instructs to change a channel.

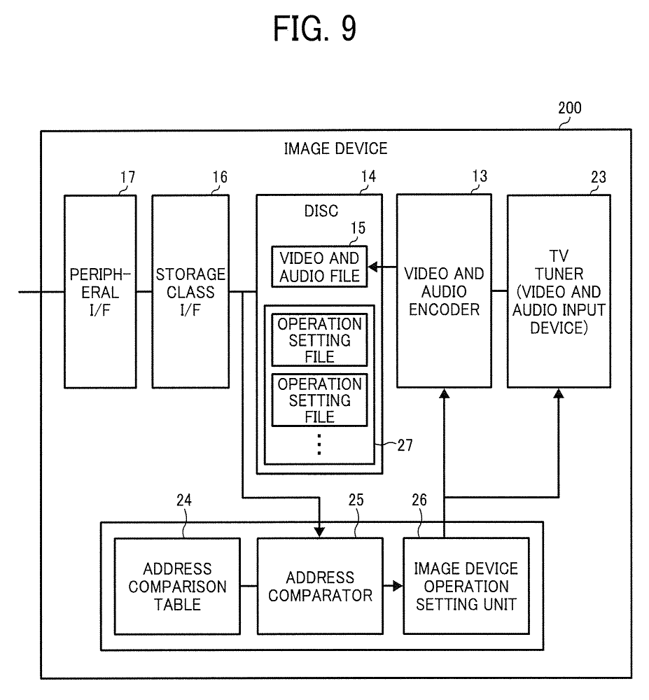

FIG. 9 is a schematic diagram illustrating an imaging device 200 according to the fifth example embodiment. The configuration of the computer 300 is omitted because its configuration is similar to that of FIG. 2. The imaging device 200 according to the fifth example embodiment stores the operation setting file 27 and the address comparison table 24 on the disk 14. Further, the imaging device 200 includes an address comparator 25 and an imaging device operation setting unit 26. The address comparator 25 and the imaging device operation setting unit 26 are implemented using a program 30 run by a CPU (Central Processing Unit) or a predetermined logic circuit.

The operations i), ii), iii) and iv) described above will now be described in more detail.

The operation setting files 27, each of which corresponds to a channel number of a television channel (for example, 1 through 12), are stored on the disk 14 of the imaging device 200. More specifically, the operation setting files 27 are, for example, CN01.txt, CN02.txt, or CN012.txt. Any nonvolatile memory can be used for the disk 14. The number of operation setting files 27 is equal to the number of channels. If each storage position of the operation setting files 27 is fixed at a predetermined reserved area of the disk 14, the physical address of the operation setting files 27 is also fixed. Accordingly, it is possible to get a correlation between the physical address and each file. The correlation between the physical address and each file is stored in the address comparison table 24. The address comparison table 24 is also stored on the disk 14:

| physical address | operation setting file |
|---|---|
| 1100 | CN01.txt |
| 1200 | CN02.txt |
| . | |
| . | |
| . | |
| 1C00 | CN012.txt |

The computer 300 can display a file name because the operation setting file 27 is stored on the same disk 14 which stores A/V file 15. If the operation setting file 27 is removed, it is not possible to change the channel. Accordingly, it is preferable that the operation setting file 27 be set to be a read-only file. Similarly, a problem may occur when the address comparison table 24 is removed or changed. Accordingly, it is preferable that the address comparison table 24 be set to be a read-only file or an invisible file. Thus, it is sufficient to use a read-only device for the disk 14.

When the file CN02.txt on the disk 14 of the imaging device 200 is read by the Windows OS(registered trademark), a flash memory controller of the imaging device 200 accesses the file CN02.txt on the disk 14 to read. Accordingly, the flash memory controller accesses an address of 1200 which is the physical address of the file CN02.txt.

The address comparator 25 obtains the address of 1200 by receiving the physical address while being accessed by the flash memory controller or by monitoring the physical addressed by the flash memory controller of the imaging device 200. Then, the address comparator 25 selects an operation setting file which matches the physical address (CN02.txt in this case) by referring to the address comparison table 24.

When the file CN02.txt is selected, the address comparator 25 reports an operational instruction of the file CN02.txt to the imaging device-operation-setting device 26. The imaging device-operation-setting device 26 then changes the channel number of the imaging device 200 to “2”. Thus, it is possible to operate and set the channel of the TV-tuner 23.

In this case, a start address of the physical address of the address comparison table 24 is used without specifying the start address or an end address. However, both the start address and the end address may be stored in the address comparison table 24, and an operational content of the operation setting files 27, which corresponds to a range between the start address and the end address, is reported to the imaging device-operation-setting device 26. Further, although in this example the operational content corresponds to a name of the operation setting files 27, it is not necessary to have a perfect correspondence when a user who operates the computer 300 understands the channel number. For example, a TV-station name may be used.

Using a similar configuration described above, it is possible to perform a start and stop operation of a recording operation by controlling the imaging device 200. For example, files REC_ST.TXT and REC_END.TXT may be stored on the disk 14. The REC_ST.TXT is an operation setting files 27 to specify the start of the recording operation, and REC_END.TXT is an operation setting files 27 to specify the end of the recording operation. Further, a relation among the files REC_ST.TXT, REC_END.TXT and physical address are created, and are stored in the address comparison table 24.

When the user selects the files REC_ST.TXT or REC_END.TXT, the address comparator 25 obtains the physical address that the flash memory controller accessed. The address comparator 25 picks up the files REC_ST.TXT or REC_END.TXT from the address comparison table 24 to request the start or stop the recording operation of the imaging device 200 to the imaging device-operation-setting device 26.

Thus, in the computer system 100 according to the fifth example embodiment, it becomes possible to control the imaging device 200 to change the channel and start and stop the recording operation from the computer 300 even when the imaging device 200 is handled as a storage device.

### Sixth Example Embodiment

In a sixth example embodiment, a computer system 100, which recognizes an imaging device 200 as both a storage device and an imaging device, will be described.

In the first through fifth example embodiments, the imaging device 200 is recognized as a storage device. However, in the sixth example embodiment, the imaging device 200 is recognized as an imaging device and can be recognized as a storage device according to the situation.

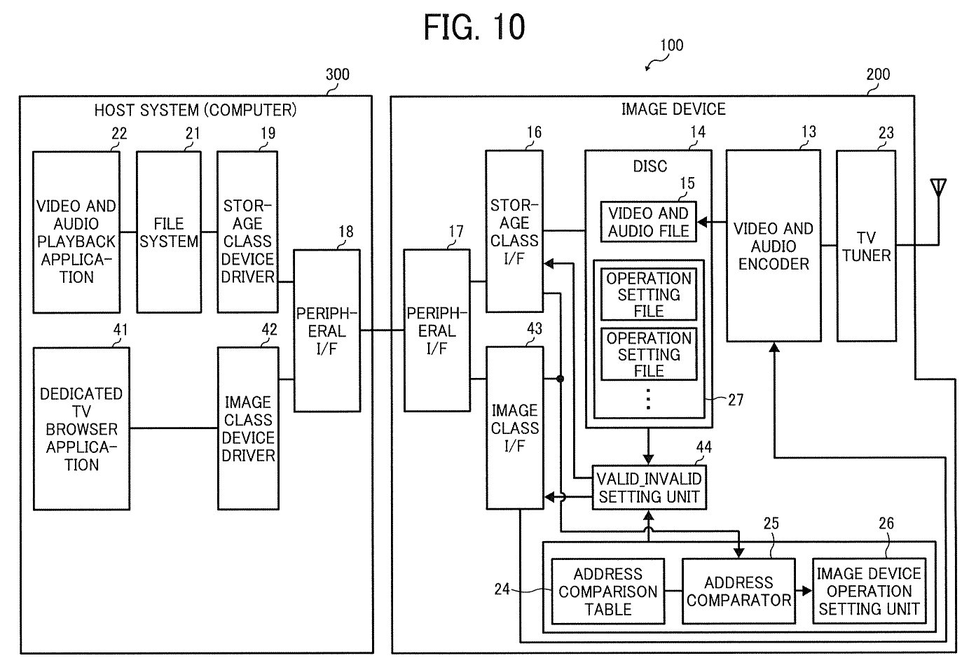

FIG. 10 is a schematic diagram illustrating the computer system 100 according to the sixth example embodiment. In the computer system 100 of FIG. 10, a computer 300 includes a dedicated TV-browse application 41 and an image-class device-driver 42. The imaging device 200 includes an image-class I/F 43 and a valid-invalid setting unit 44. The TV browse application 41 is a browse application dedicated to the TV-tuner 23. The image-class device-driver 42 is a class driver that controls operations such as a reading control of the image and the sound from the TV-tuner 23, channel operations and operational control to start and stop recording. The image-class I/F 43 is an interface that performs the interrupt transfer from the computer 300, detects commands included in the control transfer and controls data transfer in accordance with the isochronous transfer. The command detected by the storage-class I/F 16 and the image-class I/F 43 is send to the valid-invalid setting unit 44.

The valid-invalid setting unit 44 sets each function of the storage-class I/F 16 and the image-class I/F 43 valid or invalid. Similar to the computer system 100 according to the fifth example embodiment, the address comparator 25 detects the operation setting file 27 based on the physical address for the operation setting file 27 that the user selects (for example, image-yuko.txt, image-muko.txt, storage-yuko.txt, and storage-yuko.txt,). Then, the imaging device-operation-setting device 26 sends an instruction to the valid-invalid setting unit 44 to set each function of the storage-class I/F 16 and the image-class I/F 43 valid or invalid.

The valid-invalid setting unit 44 makes the storage-class I/F 16 valid when the application which the computer uses is the video-and-audio playback application 22. Further, the valid-invalid setting unit 44 makes the image-class I/F 43 valid when the application which the computer uses is the TV browse application 41. Thus, the valid-invalid setting unit 44 makes the setting flexibly in accordance with an operation status set by the user.

As described above, when the imaging device 200 is recognized as a storage device such as a USB mass storage which is being supported by the OS of the computer 300, it becomes possible to display and view the image and sound created by the imaging device 200 without the TV browse application 41 and the image-class device-driver 42.

The image-class device-driver 42 and the TV browse application 41 dedicated to the imaging device 200 are prepared for the Windows OS(registered trademark) of the computer 300. However, in Linux (registered trademark) that is other OS than the Windows OS(registered trademark), the A/V file 15 can be viewed without the TV browse application 41 and the image-class device-driver 42. Accordingly, it is possible to use minimum function of the TV-tuner 23.

However, to perform a high performance operation such as recording reservation, it may be more convenient to operate the imaging device 200 directly through the image-class device-driver 42 using the dedicated TV browse application 41 if the similar configuration to the fifth example embodiment is not included.

When the computer 300 includes the storage-class device-driver 19 and the image-class device-driver 42 and the imaging device 200 includes the storage-class I/F 16 and the image-class I/F 43, the computer 300 can recognize the imaging device 200 as both an imaging device (in broader category) and a storage device.

Accordingly, it becomes possible to provide the high performance operation using the storage-class device-driver 19 and the image-class device-driver 42, and to provide a minimum function as a storage device. Further, the storage-class I/F 16 and the image-class I/F 43 can be set valid or invalid by reading the operation setting file 27 by the valid-invalid setting unit 44. Accordingly, it is possible to use the imaging device 200 having a single function, for example, a storage function or an image function. Further, the peripheral I/F 18 between the imaging device 200 and the computer 300 can be set to use as a single function device, i.e., a storage function device or an image function device by the TV browse application 41 and the image-class device-driver 42.

### Seventh Example Embodiment

In the fifth example embodiment, it is possible to perform the channel operation and the control operation to start and stop for recording by the operation setting file 27. If the operation setting file 27 is text, followings are to be solved.

A) it is necessary to open both the video-and-audio playback application 22 and file folders (for selecting the operation setting file 27).

B) it is necessary to determine the operation from the file name of the operation setting file 27.

C) when the file name of the operation setting file 27 is not written in a language used by a user who are browsing, characters displayed are unreadable. For example, when the file name of the operation setting file 27 is written in Japanese, Japanese character can not be understood on an English system that can display only English character because the characters are garbled. Further, if a user understands Japanese only, an English file name may not be understood.

D) it may not be possible to rearrange the file names at each item desirably because the file names are not be cleaned up as a user desires. For example, file names are not rearranged correctly in alphabetic order in a specific category, where a name of “recording start” is written as A.TXT and a name of “recording end” is written as Z.TXT. Instead, other file name in other category may be inserted in the file names of the specific category.

It is convenient to display channel names in ascending order or descending order. However, the channel names may not be arranged in ascending order or descending order when the channel names are intended not to rearrange in alphabetic order or are intended to rearrange in other category such as time.

E) an opened file is needed to close when text files are handled.

These problems A) through E) described above can be solved, for example, by changing a file format of the operation setting file 27 from a text format to an HTML (Hyper Text Markup Language) format or an XML format (Extensible Markup Language).

FIG. 11 is a schematic diagram illustrating an imaging device 200 according to a seventh example embodiment. In FIG. 11, identical reference characters are assigned to identical or similar configuration members shown in FIG. 9 and descriptions thereof are omitted. In FIG. 11, CH01.HTM, CH02.HTM, . . . are stored as the operation setting file 27. Further, CH01.HTM, CH02.HTM, . . . are stored by matching the physical address thereto in the address comparison table 24.

a) it is possible to display the A/V file 15 and the operation setting file 27 in a single window by describing the operation setting file 27 to display both the A/V file 15 stored by the imaging device 200 and the operation setting file 27.

For example, HTML file 28 is described as follows to display a channel name,

```
<A Href= “CN01.HTM”>channel_1</A>
<A Href= “CN02.HTM”>channel_2</A>
    .
    .
<A Href= “CN012.HTM”>channel_12</A>
```

With this description, “channel_{—}1” and so on are displayed by a WEB browser 20, and “channel_{—}1” is linked to “CN01.HTM”, and “channel_{—}2” is linked to “CN02.HTM”. Accordingly, it becomes possible to perform channel operation from the WEB browser 20.

The HTML file 28 is described as follows to play back USBTV and ASF by the video-and-audio playback application 22.

<embed src=“usbtv.asf” autostart=“true” loop=“true” width=70 height=25>

The A/V file 15 is played back by the video-and-audio playback application 22 because of a description (embed src=“usbtv.asf”). The video-and-audio playback application 22 is determined in advance so that the video-and-audio playback application 22 is like a plug-in in the WEB browser 20. Further, the A/V file 15 is played back automatically because of a description (autostart=“true”) when the WEB browser 20 is started. According to a description (loop=“true” ), the video-and-audio playback application 22 reads and plays back the USBTV and ASF. Then, the video-and-audio playback application 22 reads rewritten USBTV and ASF. These steps are repeated.

b) a detail operation is described in the HTML file, and a described content is made hyperlink to the corresponding operation setting file 27. For example, if a file name SX01335.HTM is assigned to a recording start operation, the computer system 100 can not understand that the recording start operation is needed to be perform. However, when a hyperlink is given to start recording operation, the user can read the file name SX01335.HTM and transmit an instruction of the recording start operation to the imaging device 200 by clicking the file name SX01335.HTM. For example, HTML file 28 is described as follows.

<A Href=“SX01335.HTM”>recording_start</A>

c) The WEB browser 20 judges OS language and opens the HTML file 28 which is written by the corresponding language. As a result, it is possible to perform an arbitrary operation without being aware of the language and the file name of the operation setting file 27. For example, if Japanese OS is used, an HTML file 28 which can display Japanese character is opened and an arbitrary operation is assigned by making a hyperlink to the operation setting file 27.

d) For example, operations are described separately in a plurality of blocks using an HTML table function.

In a first block, the A/V file 15 that is stored by the imaging device 200 is displayed.

In a second block, a link of the operation setting file 27 corresponding to channel change is displayed.

In a third block, a link of the operation setting file 27 corresponding to recording start or recording stop is displayed.

With this description, it is possible to place an indication to open a related operation setting file 27 near the operation setting file 27 in an arbitrary order independently on a name of the operation setting file 27.

For example, HTML file 28 is described as follows.

```
    <table border=“5” cellspacing=“15” cellpadding=“10”>
    <tr>
    <td>
    <embed src=“usbtv.asf” autostart=“true” loop=“true”>
    </td>
    <td>
    <table border=“1”>
    <tr><td colspan=“3”>channel<td></tr>
    <tr><td> channel1</td><td> channel2</td><td>
channel3</td></tr>
    <tr><td> channel4</td><td> channel5</td><td>
channel6</td></tr>
    <tr><td> channel7</td><td> channel8</td><td>
channel9</td></tr>
    <tr><td> channel10</td><td> channel11</td><td>
channel12
    </td></tr>
    <tr><td colspan=“3”>
    <input type=“button” value=“REC START”
onClick=“location = ‘./REC_ST.htm’”><br>
    <input type=“button” value=“REC END”
onClick=“location = ‘./REC_END.htm’”>
    </td>
    </tr>
    </table>
    □/table>
```

In these HTML file 28, characters “channel_{—}1 through channel_{—}12”, “record_start” and “record_stop” are displayed. Further, a configuration and an order of an operation menu can be formed freely by linking these indications to the operation setting file 27.

e) when a link of the HTML file 28 is opened by the WEB browser 20, a content of the HTML file 28 is displayed on the WEB browser 20. Accordingly, it is possible to open the operation setting file 27 without closing a screen previously opened. Alternatively, a WEB browser 20 which has tab display function may be used.

A program for the WEB browser 20 is stored in HDD (Hard Disk Drive) of the computer 300. When the imaging device 200 is connected to the computer 300, the WEB browser 20 starts to operate automatically based on the description of the AUTORUN.INF 29 stored on the disk 14, and opens the HTML file 28. Accordingly, it becomes possible to display and operate the TV-tuner 23 automatically simply by connecting the imaging device 200.

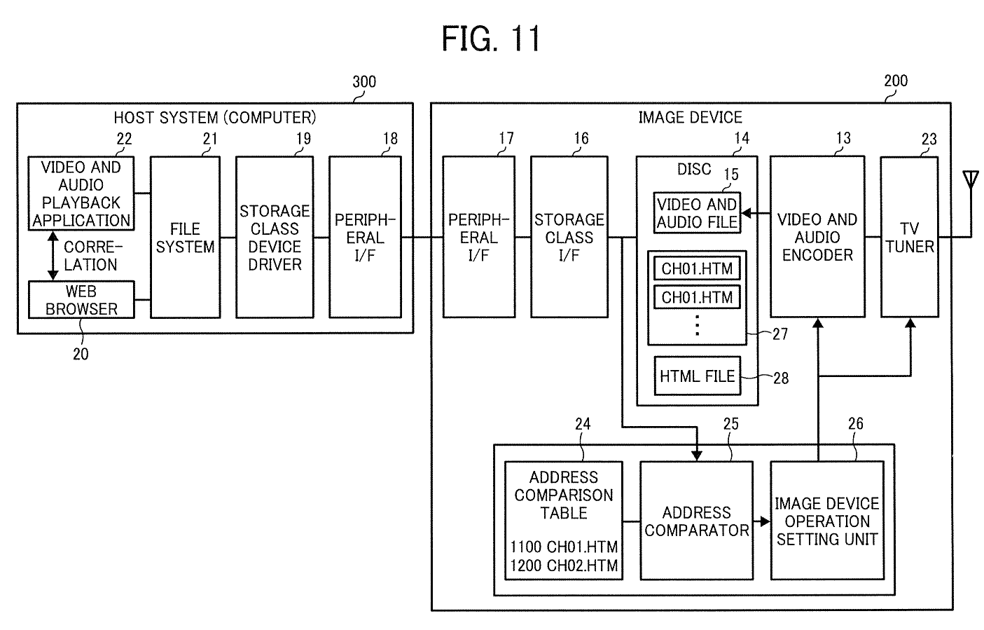

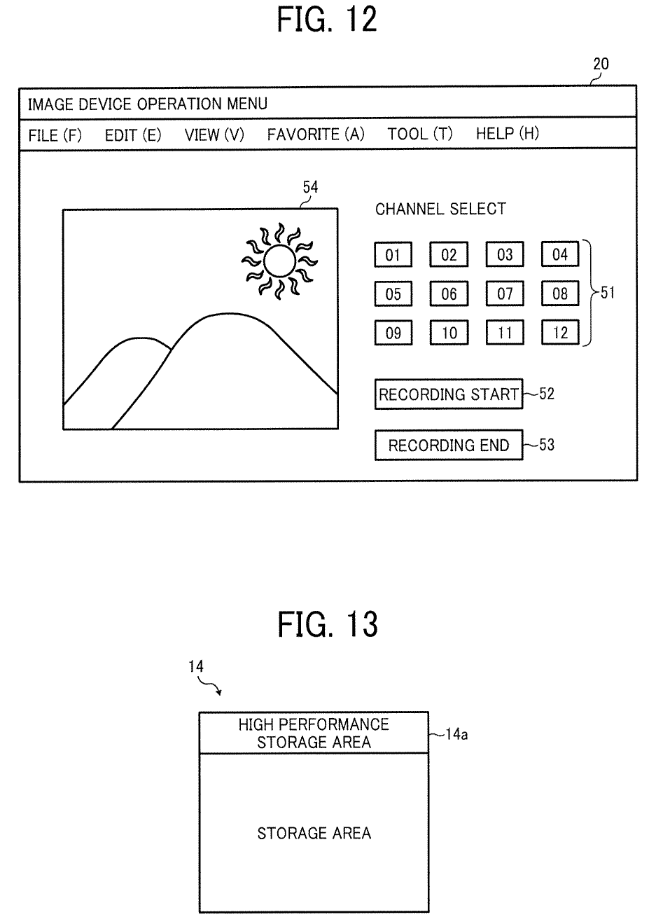

FIG. 12 is a schematic diagram illustrating an example of the operation menu of the imaging device 200 displayed in a display device when the WEB browser 20 reads the HTML file 28. The operation menu includes, channel select fields 51, a recording start button 52, a recording stop button 53 and a playback field 54 of the A/V file 15. Each channel in the channel selection fields 51, the recording start button 52 and the recording stop button 53 are linked to the operation setting file 27. Accordingly, the imaging device-operation-setting device 26 controls the imaging device 200 based on the operation that the user inputs on the WEB browser 20.

As for the playback field 54, the video-and-audio playback application 22 embedded in Windows Media Player (registered trademark) and Flash player plays back the A/V file 15.

Thus, the operation setting file 27 is linked to an HTML document, and the computer 300 operates the operation setting file 27. As a result, the computer system 100 can be operated easy.

### Eighth Example Embodiment

As described in a) of the seventh example embodiment, it is possible to manage the playback operation of the A/V file 15 and the operation of the imaging device 200 in a single window of the WEB browser 20. However, as described in e) of the seventh example embodiment, the operation setting file 27 and a file linked to the operation setting file 27 of the HTML file 28 on the WEB browser 20 are displayed on the same WEB browser 20 when the link is open. Accordingly, even if it is described on the HTML file 28 to play back the A/V file 15, a screen display of the WEB browser 20 is cleared at a start to jump to the link. The contents are not displayed until the HTML file 28 and the operation setting file 27 are read completely.

When the A/V file 15 is played back and the link of the operation setting file 27 is displayed by the single WEB browser 20, playback operation of the A/V file 15 is interrupted at the operation of the imaging device 200. The interruption is occurred even at a simple operation such as changing a sound volume of the imaging device 200.

The above problem is solved if the link between the A/V file 15 and the operation setting file 27 is displayed on another window (another screen) of the WEB browser 20.

For example, the A/V file 15 is displayed on a first window of the WEB browser 20, and the operation setting file 27 is displayed on a second window of the WEB browser 20. Accordingly, a first and second HTML files 28 are prepared.

In this case, a link to the corresponding operation setting file 27 is clicked to operate the channel change on the second window. At this moment, only the second window screen is made cleared. As a result, it is possible to read the operation setting file 27 that corresponds to the channel change operation without affecting the first window in which the A/V file 15 is being played back.

### Ninth Example Embodiment

A configuration of the disk 14 will be described. As for a streaming playback file such as ASF file, a size of the file is generally small. A transmitting side (the imaging device 200) overwrites the A/V file 15 successively, and a receiving side (the computer 300) reads the A/V file 15 successively to play back the A/V file 15. Accordingly, files are written repeatedly at a small area of the disk 14. Such area of the disk is overloaded, resulting in following failure operations. For example,

image and sound can not be played back correctly due to low reliability such as high error rate at the area in which the A/V file 15 is written,

image and sound can not be played back correctly due to destruction of the memory cell which has low durability with respect to write-and-erase cycle,

if power consumption is large, abnormal operation may occur due to heat generation or voltage drop of a battery, and

if access is slow, it is not possible to read the A/V file 15 in real time.

Accordingly, it is preferable that the disk 14 used for storage device is a storage medium having high performance, for example, high reliability, high durability with respect to write-and-erase cycle, low power consumption and high speed. However, a high performance storage medium is much more expensive than an average medium. Accordingly, the high performance storage medium (for example, SRAM and DRAM) may be used only for an area to which the A/V file 15 is recorded. As a result, it is possible to increase the reliability of the disk 14 with a minimum cost. Hereinafter, the high performance storage medium is described as a high performance storage region 14a.

FIG. 13 is a schematic diagram illustrating a configuration of the disk 14 according to a ninth example embodiment. In FIG. 13, a disk 14 includes a normal storage region and the high performance storage region 14a. The disk 14 may not be a single device but a mixture of a plurality of storages having a different performance. A maximum size of the A/V file 15 to be generated by the imaging device 200 is already fixed or can be determined. Thus, it is possible to provide a high performance storage with a low cost if an area of the high performance storage region 14a is determined and a high performance storage medium is used for the high performance storage region 14a.

### Tenth Example Embodiment

In the ninth example embodiment, the imaging device 200 which includes a plurality of storage mediums each having a different performance is described. As described in the example embodiments, the disk 14 includes a A/V file 15A for playback which the imaging device 200 stores, the operation setting file 27 which controls the operation of the imaging device 200, a A/V file 15B for recording which the imaging device 200 records. To store the A/V file 15A in the high performance storage region 14a, positioning for storing the A/V file 15A should be considered carefully. If the A/V file 15A for playback is provided unintentionally, the high performance storage region 14a may not be used to store the A/V file 15A.

The A/V file 15A is used for playback operation, and is overwritten repeatedly. The A/V file 15B is used for recording operation, and is written while a predetermined time.

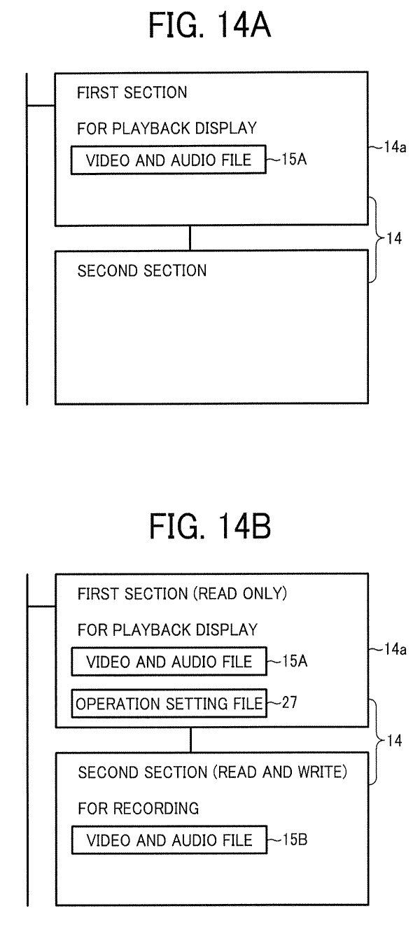

In a tenth example embodiment, the disk 14 is divided into two partitions to provide two areas. FIG. 14A is a schematic diagram illustrating a configuration of the disk 14. A high performance storage medium is employed for a first area to store the A/V file 15A for playback. A normal storage medium is employed for a second area to store other files than the A/V file 15A. Accordingly, the A/V file 15A for playback is stored reliably in the area formed of high performance storage medium.

As shown in FIG. 14B, the first area may be set to be a read-only area, and stores the A/V file 15A for playback and the operation setting file 27. Further, the second area may be set to be a read-and-write enable area, and stores the A/V file 15B for recording. Accordingly, it is possible to remove the A/V file 15B for recording, and to read and write the other files, while the A/V file 15A for playback and the operation setting file 27 are being protected.

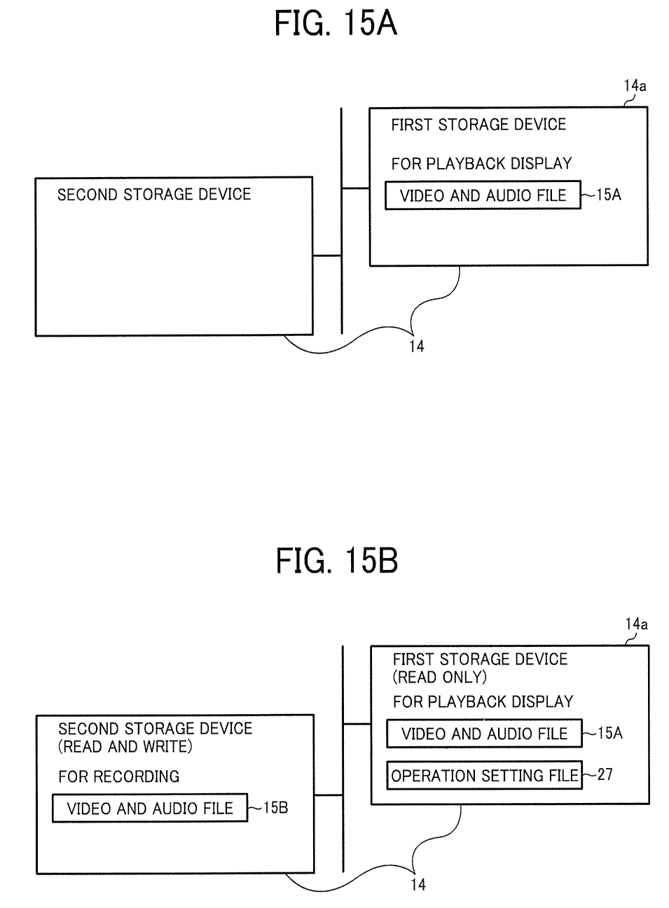

Further, as shown in FIG. 15A, two storage devices may be prepared. A high performance storage medium is employed for a first storage device to store the A/V file 15A for playback. A normal storage medium is employed for a second storage device to store other files than the A/V file 15A. Since partitions are not needed in this configuration, it is possible to store the A/V file 15A for playback reliably in the area formed of high performance storage medium.

As shown in FIG. 15B, the first storage device may be set to be a read-only area, and stores the A/V file 15A for playback and the operation setting file 27. Further, the second storage device may be set to be a read-and-write enable area, and stores the A/V file 15B for recording. With this configuration, it is possible to remove the A/V file 15B for recording, and to read and write the other files, while the A/V file 15A for playback and the operation setting file 27 are being protected.

As described above, in the computer system 100, the computer 300 can play back the A/V file 15 that the imaging device 200 generates only if the video-and-audio playback application 22 is prepared. The imaging device 200 is recognizes as a storage device according to the example embodiments. Generally, it is easy to obtain the video-and-audio playback application 22 if the device driver of the storage device is supported by the OS and the A/V file 15 meets the MPEG standard. Accordingly, it is not necessary for a user to purchase the software and install to achieve the computer system 100.

Further, the imaging device 200 is recognized as a storage device according to the example embodiments. Accordingly, it is possible to record the A/V file 15 using an apparatus having no storage device such as NAS. (For example, when the computer system 100 is operating by the NAS function of the router)

Further, the A/V file 15 may be set to be a read-only file. Accordingly, it is not possible to remove the A/V file 15 from the computer 300 by an instruction and by a physical or a logical formatting even if the imaging device 200 is recognizes as a storage device. Thus, the file can not be lost if the A/V file 15 is set to be a read-only file.

Further, it becomes possible to play back automatically using automatic playback function for an optical disk when the computer 300 detects a connection of the imaging device 200 as an optical disk such as CD-ROM if the computer 300 recognizes the imaging device 200 as an optical disk, and performs procedure written in the setting files AUTORUN and INF29. Accordingly, it is not needed to run a dedicated resident software necessary for playing back the imaging device 200 automatically.

Further, it is possible to control an operation of the imaging device 200 by storing the operation setting file 27 on the disk 14 and detecting the physical address being accessed. Accordingly, it is possible to control the operation the imaging device 200 without implementing a dedicated operational program, a Web server program and a system program such as CGI (Common Gateway Interface). This system configuration is applicable to other device than the imaging device 200.

Further, it is possible to make layering and linking of the files by linking the contents of operation and the operation setting file 27 to the HTML file 28. Accordingly, it becomes possible to view, operate and arrange the operation menu.

Further, it is possible that the storage device is durable for more read-and-write cycle if a volatile memory (SRAM, DRAM) is used at the area in which the A/V file 15 is stored.

Further, the A/V file 15A for playback and the A/V file 15B for recording are stored in different partitions. Accordingly, the A/V file 15A for playback and the HTML file 28 can be determined to be write inhibit, and the A/V file 15B for recording can be determined to be erasable.

Further, the imaging device 200 can be operated directly by a dedicated application when the imaging device 200 is recognized as both the storage device and the imaging device.

Numerous additional modifications and variations are possible in light of the above teachings. It is therefore to be understood, that within the scope of the appended claims, the disclosure of this patent specification may be practiced otherwise than as specifically described herein.

What is claimed is:

1. An information playback system comprising:
a first information processor and a second information processor,
the first information processor configured to generate digital data based on image or sound and including:
an encoder to encode the image or the sound as digital data;
a storage to store the digital data;
a first hardware interface to connect the first information processor to the second information processor; and
a storage-class software interface to permit the second information processor to access the storage without using an image-class software interface,
the second information processor configured to playback the digital data and including:
a second hardware interface to connect the second information processor to the first information processor;
a software interface to mount the storage to a file system; and
a playback device to playback the digital data.

2. The information playback system according to claim 1,
wherein the encoder handles the digital data for a predetermined time as a single file to store the digital data in the storage.

3. The information playback system according to claim 1,
wherein automatic-playback-request information that requests to start the playback device is stored in the storage of the first information processor, and the second information processor detects the automatic-playback-request information and causes the playback device to operate when the storage is mounted on the file system.

4. The information playback system according to claim 1,
wherein the storage stores, at predetermined addresses, a plurality of operational setting files in which an operation method of the first information processor is registered, and an address comparison table in which identifying information for the operational setting files is registered at corresponding addresses,
the first information processor further comprising:
an address comparator configured to reference the address comparison table based on an address being accessed when the second information processor accesses the operational setting file and extract the operational setting file which corresponds to the address being accessed; and
an operational setting unit configured to control the first information processor based on the operational setting file being extracted.

5. The information playback system according to claim 4,
the first information processor further comprising:
an image-class software interface configured to transmit the digital data to the second information processor; and
a valid-invalid setting unit configured to exchange valid or invalid on the image-class software interface and the storage-class software interface when the second information processor accesses the operational setting file.

6. The information playback system according to claim 5,
wherein the valid-invalid setting unit exchanges valid or invalid on the image-class software interface and the storage-class software interface depending on a request of the second information processor which requests the image-class software interface or storage-class software interface.

7. The information playback system according to claim 6,
wherein the storage stores a markup language file that includes an operation menu written in a markup language and the operation menu has links to identification information of the operational setting file.

8. The information playback system according to claim 7,
the second information processor further comprising a user interface display unit configured to display a user interface, which is generated by associating with the playback unit and interpreting the markup language, on a display device,
wherein the user interface display unit reads the markup language file from the storage, displays the operation menu on the user interface, and starts the playback unit in the user interface.

9. The information playback system according to claim 7,
the second information processor further comprising a user interface display unit configured to display a user interface, which is generated by associating with the playback unit and interpreting the markup language, on a display device,
wherein the user interface display unit displays the operation menu on a first user interface, and start the playback unit in a second user interface that is different from the first user interface.

10. The information playback system according to claim 1,
wherein the storage is divided into a plurality of storage areas, one of the storage areas is used only to store the playback data, and another one of storage areas is used to store the digital data only or the digital data and the operational setting file.

11. The information playback system according to claim 1,
wherein the storage comprises a plurality of storage media, one of the storage areas is used only to store the playback data, and another one of storage areas is used to store the digital data only or the digital data and the operational setting file.

12. A data generation apparatus to generate digital data from image or sound, comprising:
an encoder to encode image or sound to digital data;
a storage to store the digital data;
a hardware interface to connect an information processor; and
a storage-class software interface to permit the information processor to access the storage without using an image-class software interface.

13. The data generation apparatus according to claim 12,
wherein automatic-playback-request information that requests to start a playback device to play back the digital data is stored in the storage.

14. The data generation apparatus according to claim 12,
wherein the storage stores a plurality of operational setting files at predetermined addresses and stores an address comparison table, in which identifying information for the operational setting files is registered at corresponding addresses,
and wherein the data generation apparatus further comprises:
an address comparator configured to reference the address comparison table based on an address being accessed when the information processor accesses the operational setting file, and extracts the operational setting file which corresponds to the address being accessed; and
an operational setting unit configured to control the data generation apparatus based on the operational setting file being extracted.

15. The data generation apparatus according to claim 14,
the data generation apparatus further comprising:
an image-class software interface configured to transmit the digital data to the information processor;
a valid-invalid setting unit configured to exchange valid or invalid on the image-class software interface and the storage-class software interface when the information processor accesses the operational setting file.

16. The data generation apparatus according to claim 15,
wherein the valid-invalid setting unit exchanges valid or invalid on the image-class software interface and the storage-class software interface depending on a request of the information processor which requests the image-class software interface or storage-class software interface.

17. The data generation apparatus according to claim 15,
wherein the storage stores a markup language file that includes an operation menu written in a markup language and the operation menu has links to identification information of the operational setting file.

18. A data playback apparatus to play back digital data generated by an information processor,
the information processor including:
an encoder to encode image or sound to digital data;
a storage to store the digital data;
a hardware interface to connect the information; and
a storage-class software interface to permit the information processor to access the storage without using an image-class software interface,
the data playback apparatus comprising:
a hardware interface to connect the information processor;
a software interface to mount the storage to a file system, and
a playback device to playback the digital data.
